(19) United States
(12) Patent Application Publication
(10) Pub. No.: US 2025/0201465 A1
(43) Pub. Date: Jun. 19, 2025

(54) CURRENT TRANSFORMER HOLDER

(71) Applicant: Delta Electronics, Inc., Taipei (TW)

(72) Inventor: Vincent Mark Byrne, Plano, TX (US)

(21) Appl. No.: 18/972,154

(22) Filed: Dec. 6, 2024

Related U.S. Application Data
(60) Provisional application No. 63/610,271, filed on Dec. 14, 2023.

(51) Int. Cl. H01F 27/06

(52) U.S. Cl. CPC H01F 27/06

(57) ABSTRACT

A current transformer holder includes a base, plural first position-limiting elements, plural second position-limiting elements, an opening and at least one guiding element. The base includes a first surface and a second surface opposite to each other. The first position-limiting elements are disposed on the first surface of the base for maintaining the current transformer holder in a passage of a current transformer. The second position-limiting elements are respectively disposed on the first position-limiting elements for defining a positional relationship between the current transformer holder and the current transformer. The opening is disposed on the base for being penetrated by the conductor so as to define a position of the conductor within the passage. The guiding element is disposed on the base at a position corresponding to the opening for guiding a direction of the conductor within the passage of the current transformer.

### CROSS-REFERENCE TO RELATED APPLICATIONS

This application claims the benefit of U.S. Provisional Application Ser. No. 63/610,271 filed on Dec. 14, 2023. The entire contents of the above-mentioned application are incorporated herein by reference for all purposes.

### FIELD OF THE INVENTION

The present disclosure is related to a current transformer holder, and more particularly to a current transformer holder for holding a conductor penetrating a passage of a current transformer.

### BACKGROUND OF THE INVENTION

Window-type current transformers which are used to measure electrical current in a conductor passing through the passage thereof must be mechanically supported. Generally, the conventional current transformer holder rigidly couples the fragile current transformer to the conductor. This requires much labor to install the current transformer holder and inspect hardware, and the current transformer is vulnerable to damage from transportation, earthquake shock, and vibrations from the conductor.

Therefore, there is a need of providing an improved current transformer holder.

### SUMMARY OF THE INVENTION

An object of the present disclosure is to provide a current transformer holder for addressing the above-discussed deficiencies in the prior arts.

Another object of the present disclosure is to provide a current transformer holder for assembling in a passage of a current transformer and holding a conductor penetrating the passage of the current transformer in a self-aligning manner without employing additional fixing elements.

In accordance with an aspect of the present disclosure, a current transformer holder for holding a conductor penetrating a passage of a current transformer is provided. The current transformer holder includes a base, a plurality of first position-limiting elements, a plurality of second position-limiting elements, an opening, and at least one guiding element. The base includes a first surface and a second surface opposite to each other. The plurality of first position-limiting elements are disposed on the first surface of the base for maintaining the current transformer holder in the passage of the current transformer. The plurality of second position-limiting elements are respectively disposed on the plurality of first position-limiting elements for defining a positional relationship between the current transformer holder and the current transformer. The opening is disposed on the base for being penetrated by the conductor so as to define a position of the conductor within the passage of the current transformer. The at least one guiding element is disposed on the base at a position corresponding to the opening for guiding a direction of the conductor within the passage of the current transformer.

In an embodiment, the current transformer includes a third surface and a fourth surface opposite to each other, and when the current transformer holder is assembled with the current transformer, the first surface of the base is abutted on the third surface, the plurality of first position-limiting elements are abutted on at least one inner edge surface of the passage, and the plurality of second position-limiting elements are abutted on the fourth surface of the current transformer.

In an embodiment, the plurality of first position-limiting elements are extended from the first surface of the base in a direction substantially parallel to a normal direction of the first surface and form a space thereamong, and each of the plurality of second position-limiting elements is extended from a corresponding one of the plurality of first position-limiting element in a direction away from the space.

In an embodiment, the opening is located at a position corresponding to the space, and the at least one guiding element is extended in the space.

In an embodiment, the plurality of first position-limiting elements are arranged in pairs, and every two paired ones of the plurality of first position-limiting elements are disposed at opposite positions.

In an embodiment, extension directions of the plurality of second position-limiting elements are substantially parallel to the first surface of the base.

In an embodiment, the at least one guiding element is extended from the first surface or from the first surface and the second surface of the base in a direction substantially parallel to a normal direction of the first surface and substantially parallel to extension directions of the plurality of first position-limiting elements.

In an embodiment, each of the at least one guiding element includes an extending element and at least one fixing element, the extending element supports the conductor, and the at least one fixing element fixes with at least one corresponding fixing portion on the conductor.

In an embodiment, the at least one guiding element is configured to mate to an outer surface of the conductor.

In an embodiment, a shape of the opening is substantially identical to a section shape of the conductor.

In an embodiment, the current transformer holder further includes a surrounding structure protruded from the second surface of the base to form the opening.

In an embodiment, the current transformer holder is integrally formed as one piece.

In an embodiment, the passage of the current transformer has a shape selected from the group consisting of a rectangular shape, a circular shape, a stepped shape and an arbitrary shape.

In accordance with another aspect of the present disclosure, a current transformer holder for holding a conductor penetrating a passage of a current transformer is provided. The current transformer holder includes a first base, a second base, a plurality of first position-limiting elements, an opening and at least one guiding element. The first base includes a first surface and a second surface opposite to each other. The second base is parallel to the first base and adjacent to the first surface of the first base. The plurality of first position-limiting elements are disposed between the first base and the second base for maintaining the current transformer holder in the passage of the current transformer. The opening is disposed on the first base for being penetrated by the conductor so as to define a position of the conductor within the passage of the current transformer. The at least one guiding element is disposed on the first base at a position corresponding to the opening for guiding a direction of the conductor within the passage of the current transformer.

In an embodiment, the current transformer includes a third surface and a fourth surface opposite to each other, and when the current transformer holder is assembled with the current transformer, the first surface of the first base is abutted on the third surface, the plurality of first position-limiting elements are abutted on at least one inner edge surface of the passage, and the second base is abutted on the fourth surface of the current transformer.

In an embodiment, the plurality of first position-limiting elements are extended in a direction substantially parallel to a normal direction of the first surface and form a space thereamong.

In an embodiment, the second base includes a hollow portion disposed thereon at a position corresponding to the space among the plurality of first position-limiting elements.

In an embodiment, the opening is at a position corresponding to the space, and the at least one guiding element is extended in the space.

In an embodiment, the current transformer holder further includes a surrounding structure protruded from the second surface of the first base to form the opening.

In an embodiment, the at least one guiding element is extended from the first surface or from the first surface and the second surface of the first base in a direction substantially parallel to a normal direction of the first surface and substantially parallel to extension directions of the plurality of first position-limiting elements.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1 is a schematic view illustrating a current transformer holder according to an embodiment of the present disclosure;

FIG. 2 is a schematic view illustrating the current transformer holder in FIG. 1 assembling with a current transformer having a passage, and a conductor penetrating the passage of the current transformer;

FIG. 3A is a front view of the assembly in FIG. 2;

FIG. 3B is a side view of the assembly in FIG. 2;

FIG. 4 is a front view of an assembly of a current transformer holder according to another embodiment of the present disclosure with a current transformer having a passage, and a conductor penetrating the passage of the current transformer;

FIG. 5 is a schematic view illustrating a current transformer holder according to another embodiment of the present disclosure;

FIGS. 6A-6B are schematic views illustrating the current transformer holder in FIG. 5 respectively assembling with current transformers having different passages, and conductors penetrating the passages of the current transformers;

FIG. 7A is a schematic view illustrating a current transformer holder according to another embodiment of the present disclosure assembling with a current transformer having a passage, and a conductor penetrating the passage of the current transformer;

FIG. 7B is a schematic view illustrating the assembly in FIG. 7A from another view angle;

FIG. 8 is a schematic view illustrating a current transformer holder according to another embodiment of the present disclosure;

FIG. 9 is a schematic view illustrating the current transformer holder in FIG. 8 assembling with a current transformer having a passage, and a conductor penetrating the passage of the current transformer;

FIG. 10A is a schematic view illustrating a current transformer holder according to another embodiment of the present disclosure assembling with a current transformer having a passage, and a conductor penetrating the passage of the current transformer; and

FIG. 10B is a schematic view illustrating the assembly in FIG. 10A from another view angle.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

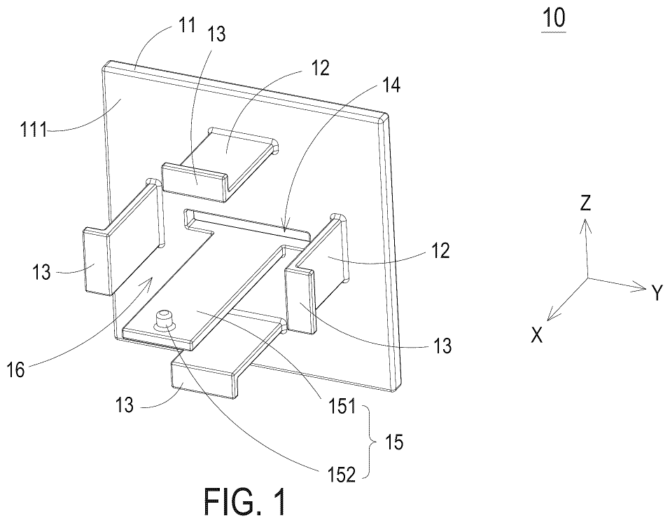

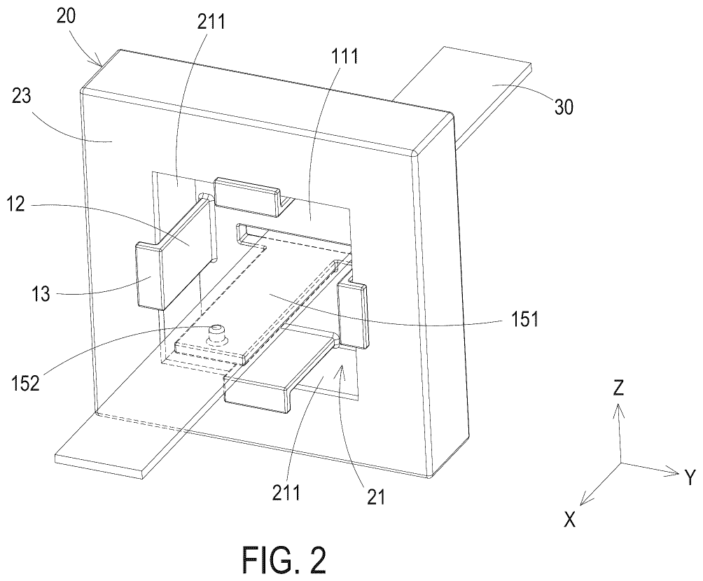

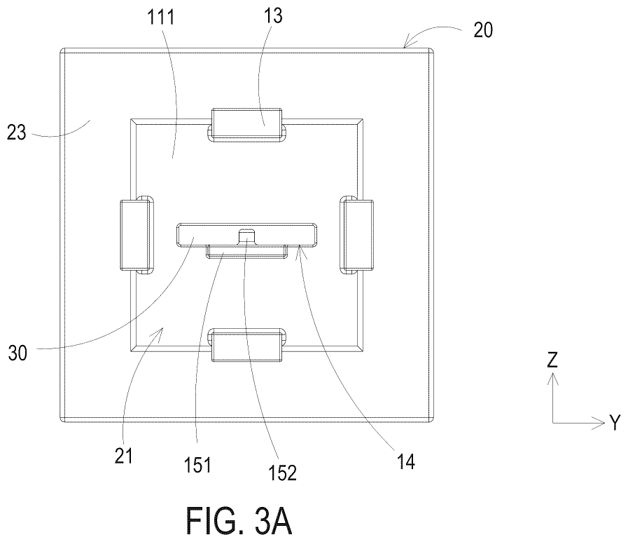

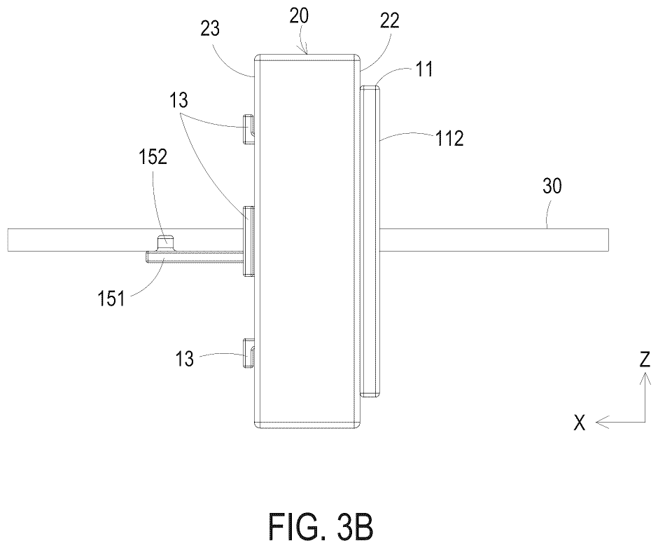

Please refer to FIG. 1, FIG. 2 and FIGS. 3A-3B. FIG. 1 is a schematic view illustrating a current transformer holder according to an embodiment of the present disclosure, FIG. 2 is a schematic view illustrating the current transformer holder in FIG. 1 assembling with a current transformer having a passage, and a conductor penetrating the passage of the current transformer, FIG. 3A is a front view of the assembly in FIG. 2, and FIG. 3B is a side view of the assembly in FIG. 2. In the embodiment, a current transformer holder 10 is provided for assembling with a current transformer 20 having a passage 21 in a rectangular shape, so as to hold a conductor 30 penetrating the passage 21 of the current transformer 20. The current transformer holder 10 includes a base 11, first position-limiting elements 12, second position-limiting elements 13, an opening 14 and a guiding element 15. The base 11 includes a first surface 111 and a second surface 112 opposite to each other. The first position-limiting elements 12 and the guiding element 15 are disposed on the base 11, the second position-limiting elements 13 are respectively disposed on the first position-limiting elements 12, and the opening 14 is formed on the base 11. The first position-limiting elements 12 are extended from the first surface 111 in a direction substantially parallel to a normal direction of the first surface 111, namely, in an X axis direction, so that a space 16 is formed among the first position-limiting elements 12. The opening 14 is located at a position substantially at the center of the first position-limiting elements 12, namely, at a position corresponding to the space 16. The guiding element 15 is disposed adjacent to the opening 14 and extended in a direction substantially parallel to the normal direction of the first surface 111, so that the guiding element 15 is located in the space 16 and substantially parallel to the first position-limiting elements 12. In some embodiments, the guiding element 15 can be implemented to extend from one surface of the base 11, namely, from the first surface 111, toward a substantially same direction with the first position-limiting elements 12, and in some other embodiments, the guiding element 15 also can be implemented to extend from opposite surfaces of the base 11, namely, from the first surface 111 and the second surface 112, so as to form the guiding element 15 penetrating the base 11. Each second position-limiting element 13 is disposed at a distant end of a corresponding first position-limiting element 12 relative to the base 11 and is extended from the corresponding first position-limiting element 12 in a direction away from the space 16 and substantially parallel to the first surface 111 of the base 11.

When the current transformer holder 10 is assembled with the current transformer 20, the space 16 of the current transformer holder 10 is corresponding to the passage 21 of the current transformer 20, and the first position-limiting elements 12 with the second position-limiting elements 13 and the guiding element 15 are penetrated through the passage 21. Accordingly, the first surface 111 of the base 11 is abutted on a third surface 22 of the current transformer 20, the first position-limiting elements 12 are abutted on inner edge surfaces 211 of the passage 21 of the current transformer 20, and the second position-limiting elements 13 are abutted on a fourth surface 23 of the current transformer 20 which is opposite to the third surface 22. Through the abutting between the first position-limiting elements 12 and the inner edge surfaces 211 of the passage 21, the current transformer holder 10 is maintained in the passage 21 of current transformer 20, namely, the position of the current transformer 20 in the Y-Z plane relative to the current transformer holder 10 is fixed thereby. Through the second position-limiting elements 13 abutting on the fourth surface 23, the positional relationship between the current transformer holder 10 and the current transformer 20 is further defined, that is, the position of the current transformer holder 10 in the X axis direction relative to the current transformer 20 is fixed thereby. Then, the opening 14 is located at a position corresponding to the passage 21, and the guiding element 15 is suspended in the passage 21.

Preferably but not exclusively, the first position-limiting elements 12 and/or the second position-limiting elements 13 flex as the current transformer holder 10 penetrates the passage 21 and then snap back to abut on the inner edge surfaces 211 and/or the fourth surface 23 of the current transformer 20, thereby positioning the current transformer holder 10 in the passage 21.

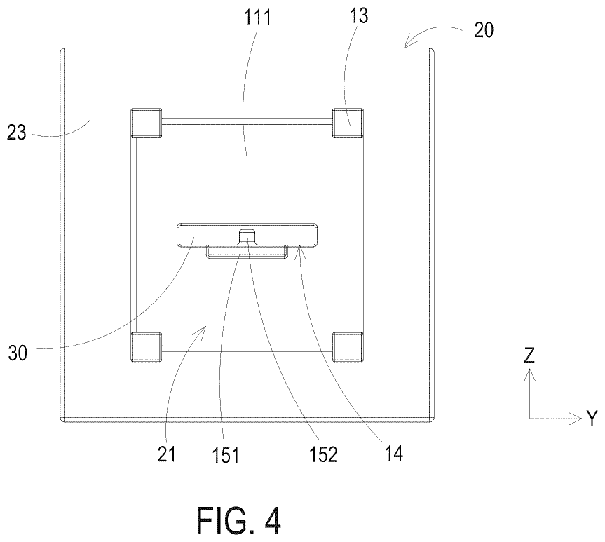

Preferably but not exclusively, the first position-limiting elements 12 are arranged in pairs, and the first position-limiting elements 12 in each pair are disposed in opposite positions, so that the paired first position-limiting elements 12 can abut at opposite positions of the inner edge surfaces 211 of the passage 21 so as to provide supporting forces in opposite directions, thereby further stabilizing the current transformer holder 10 in the passage 21. For example, as shown in FIG. 3A, the first position-limiting elements 12 are respectively disposed at four sides of the rectangular-shaped passage in opposite oppositions, such as one pair disposed in a Z axis direction and the other pair disposed in a Y axis direction; or as shown in FIG. 4, the first position-limiting elements 12 with the second position-limiting element 13 are respectively disposed at four corners of the rectangular-shaped passage 21 in opposite positions, such as two pairs in the Z direction or two pairs in the Y direction.

The opening 14 is used to be penetrated by the conductor 30. As shown in FIG. 2, the opening 14 narrows down the range of the passage 21 of the current transformer 20, so that the movement of the penetrated conductor 30 within the passage 21 can be reduced. Preferably but not exclusively, the shape of the opening 14 is configured to mate to the outer surface of the conductor 30, so as to further define the position of the conductor 30 penetrating the passage 21. For example, as shown in FIG. 3A, the conductor 30 has a rectangular cross section, and the opening 14 is configured to have a similar rectangular shape for penetrating thereof the conductor 30, thereby minimizing the movement of the conductor 30 within the passage 21. The guiding element 15 is used to guide the direction of the conductor 30 within the passage 21. In some embodiments, the guiding element 15 includes an extending element 151 extended from the first surface 111, and a fixing element 152 disposed on a distant end of the extending element 151 relative to the base 11. In some other embodiments, the guiding element 15 includes an extending element 151 extended from opposite surfaces of the base 11, and fixing element(s) 152 disposed on one of or two ends of the extending element 151. When the conductor 30 is penetrated through the opening 14, the extending element 151 flexes and the fixing element(s) 152 travels on the surface of the conductor 30 until fixing into corresponding fixing portion(s) (not shown) on the conductor 30, thereby limiting the direction of the conductor 30 after penetrating the opening 14. For example, the extending element 151 can be implemented as a beam for supporting the conductor 30, and the fixing element(s) 152 can be implemented as pin(s) for fixing in hole(s) on the conductor 30, but not limited thereto.

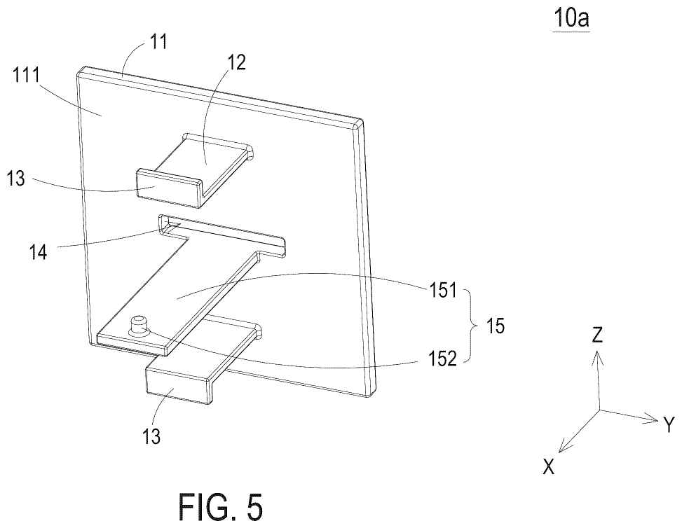

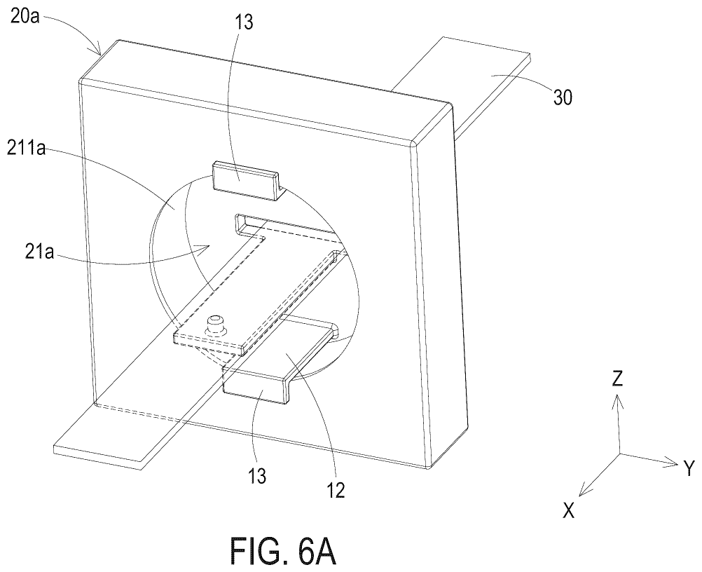

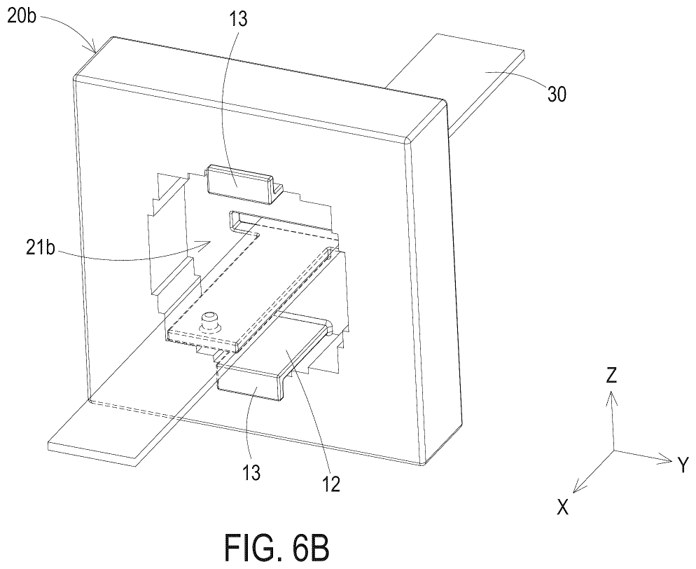

Moreover, the current transformer holder of the present disclosure can adapt to different shapes of passages of the current transformer through varying the number and the positions of the first position-limiting elements. Please refer to FIG. 5 and FIGS. 6A-6B. FIG. 5 is a schematic view illustrating a current transformer holder according to another embodiment of the present disclosure, and FIGS. 6A-6B are schematic views illustrating the current transformer holder in FIG. 5 respectively assembling with current transformers having different passages, and the conductors penetrating the passages of the current transformers. In the embodiment, different from the embodiment in FIG. 1, a current transformer holder 10a in FIG. 5 includes two first position-limiting elements 12 and two corresponding second position-limiting elements 13. For example, as shown in FIG. 5, the two first position-limiting elements 12 are located at opposite positions in the Z axis direction. In one exemplary application, the current transformer holder 10a is assembled with a current transformer 20a having a passage 21a in a circular shape as shown in FIG. 6A. This is especially advantageous that the current transformer holder 10a can move along the Y-Z plane, namely, along the inner edge surface 211a of the passage 21a, so as to adapt to a desired orientation of the conductor 30 with a rectangular cross section. In another exemplary application, the current transformer holder 10a is assembled with a current transformer 20b having a passage 21b in a stepped shape as shown in FIG. 6B. As needed, the current transformer holder 10a can be rotated 90 degrees along the Y-Z plane for adapting to a desired orientation of the conductor 30 with a rectangular cross section. Therefore, the current transformer holder 10a provides the flexibility of adapting to different shapes of passages of the current transformer. Of course, the current transformer holders 10 shown in FIG. 1 and FIG. 4 also can be assembled with the current transformers 20a, 20b if the positions and/or the shape of the first position-limiting elements 12 can match the shape of the passages 21a, 21b, without limitation. For example, the first position-limiting elements 12, in FIG. 1, FIG. 4 and FIG. 5, may be formed to be cambered elements so as to match the circular shape of the passage 21a of the current transformer 20a, as shown in FIG. 6A, or formed to locate at positions corresponding to variations of the shape of the passage 21b of the current transformer 20b, as shown in FIG. 6B. Therefore, the number and the detailed structures of the first position-limiting elements 12 can be varied to adapt to any kind of shape of the passage, such as a rectangular shape, a circular shape, a stepped shape or an arbitrary shape, according to practical requirements without limitation.

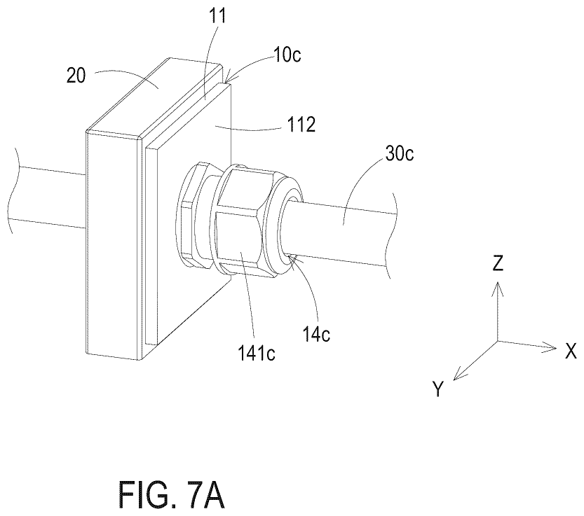

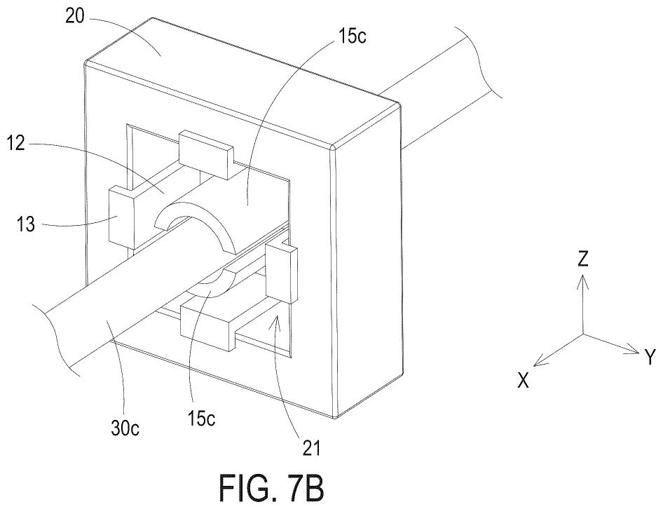

Furthermore, in response to different types of conductors penetrating the current transformer, the opening and the guiding element of the current transformer holder of the present disclosure also can be varied. In an embodiment, as shown in FIGS. 7A-7B, a conductor 30c is a cable or a rod with a round section. Accordingly, a current transformer holder 10c is provided, wherein an opening 14c is configured to have a similar round section for limiting the movement of the penetrated conductor 30c, and guiding elements 15c are respectively configured as cambered elements, such as two cambered elements in opposite positions, for surrounding the outer surface of the conductor 30c so as to guide the direction of the conductor 30c through clamping or friction. In an embodiment, the current transformer holder 10c further includes a surrounding structure 141c protruded from the second surface 112 of the base 11 to form the opening 14c, so as to cooperate with the guiding elements 15c for further ensuring the direction of the penetrated conductor 30c in the passage 21, but not limited thereto. In other embodiments, it also can be implemented to employ single guiding element 15c or more than two guiding elements 15c to mate to the conductor with the round section in accordance with practical requirements without limitation. In other embodiments, the guiding element(s) may be configured to be any structure capable of providing the function of clamping and/or friction, such as a clamp, a wire tie or a gland, but not limited thereto. Therefore, the number and detailed structures of the guiding element(s) and the shape of the opening can be varied according to practical requirements for achieving the purpose of fixing and/or holding the conductor without limitation.

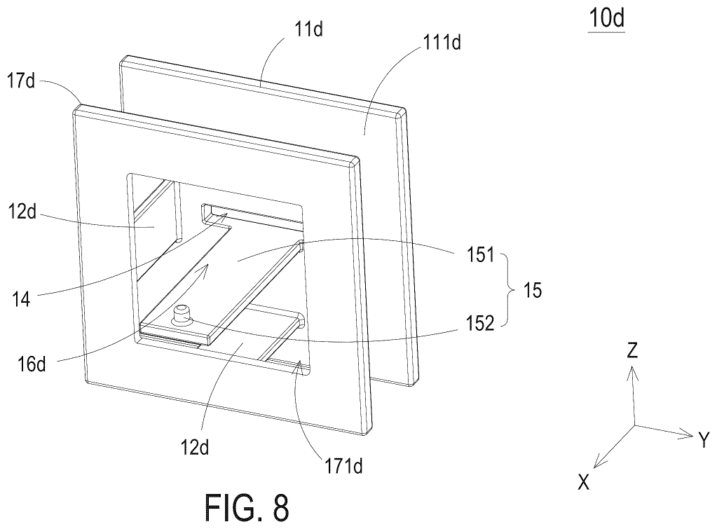

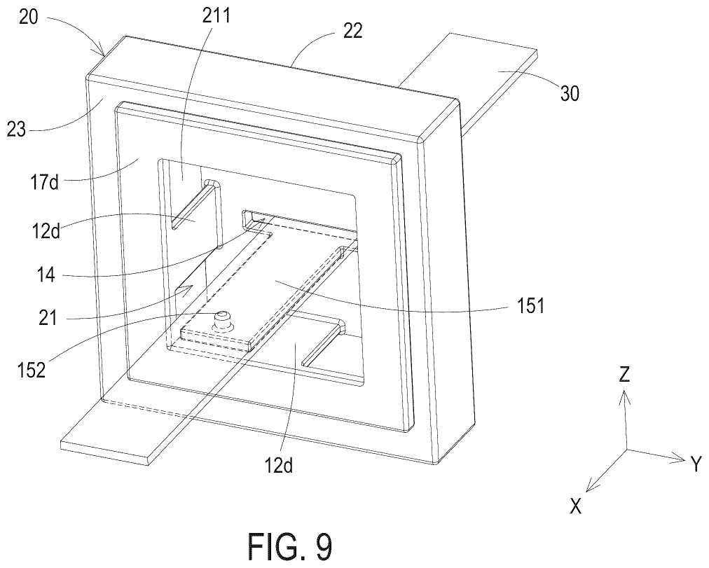

In another aspect of the present disclosure, a current transformer holder according to another embodiment is shown in FIG. 8, and an assembly of the current transformer holder in FIG. 8 with a current transformer having a passage, and a conductor penetrating the passage of the current transformer is shown in FIG. 9. In the embodiment, a current transformer holder 10d is provided for assembling with a current transformer 20 having a passage 21 so as to hold a conductor 30 penetrating the passage 21 of the current transformer 20. The current transformer holder 10d includes a first base 11d, a second base 17d, first position-limiting elements 12d, an opening 14, and a guiding element 15. The first base 11d and the second base 17d are substantially parallel to each other, and the second base 17d is adjacent to the first surface 111d of the first base 11d. The first position-limiting elements 12d are disposed between the first base 11d and the second base 17d and respectively connected thereto, and form a space 16d thereamong. The opening 14 is formed on the first base 11d at a position corresponding to the space 16d. The guiding element 15 is disposed on the first base 11d and suspended in the space 16d, and the extension direction thereof is substantially parallel to the extension directions of the first position-limiting elements 12d. In some embodiments, the guiding element 15 can be implemented to extend from the first surface 111d of the first base 11d toward the second base 17d, and in some other embodiments, the guiding element 15 also can be implemented to extend from opposite surfaces of the first base 11d, namely, toward and away from the second base 17d, so as to form the guiding element 15 penetrating the first base 11d. The second base 17d includes a hollow portion 171d disposed thereon at a position corresponding to the space 16d, namely, the hollow portion 171d exposes the opening 14 and the guiding element 15. In an embodiment, the first base 11d, the first position-limiting elements 12d and the guiding element 15 are integrally formed as one piece, and the second base 17d is assembled thereto; in another embodiment, the first base 11d and the guiding element 15 are integrally formed as one piece, the first position-limiting elements 12d and the second base 17d are integrally formed as one piece, and two pieces are assembled together to form the current transformer holder 10d; in other embodiments, the current transformer holder 10d is formed in another assembling manner without limitation.

When the current transformer holder 10d is assembled with the current transformer 20, the first surface 111d of the first base 11d is abutted on the third surface 22 of the current transformer 20, the second base 17d is abutted on the fourth surface 23 of the current transformer 20 which is opposite to the third surface 22, and the first position-limiting elements 12d are penetrated through the passage 21 and abutted on the inner edge surfaces 211 of the passage 21 of the current transformer 20. Accordingly, the current transformer 20 is limited between the first base 11d and the second base 17d, the opening 14 is located at a position within the range of the passage 21, and the guiding element 15 is suspended in the passage 21. The position of the current transformer holder 10d in the Y-Z plane relative to the current transformer 20 is maintained through the abutting between the first position-limiting elements 12d and the inner edge surfaces 211 of the passage 21, and the positional relationship between the current transformer holder 10d and the current transformer 20 in the X axis direction is fixed by the first base 11d and the second base 17d. In other words, the second base 12d provides the similar function to the second position-limiting elements 13 as described in the previous embodiments.

The opening 14 is used to penetrate thereof the conductor 30. As shown, the opening 14 narrows down the range of the passage 21 of the current transformer 20, so that the movement of the penetrated conductor 30 within the passage 21 can be reduced. Preferably but not exclusively, the shape of the opening 14 is configured to mate to the outer surface of the conductor 30, so as to further define the position of the conductor 30 penetrating the passage 21. For example, the conductor 30 has a rectangular cross section, and the opening 14 is configured to have a similar rectangular shape for penetrating thereof the conductor 30, thereby minimizing the movement of the conductor 30 within the passage 21. The guiding element 15 is used to guide the direction of the conductor 30 within the passage 21. In some embodiments, the guiding element 15 includes the extending element 151 extended from the first surface of the first base 11d toward the second base 17d, and the fixing element 152 disposed on the distant end of the extending element 151 relative to the first base 11d. In some other embodiments, the guiding element 15 includes the extending element 151 extended from opposite surfaces of the first base 11d, and fixing element(s) 152 disposed on one of or both distant ends of the extending element 151. When the conductor 30 is penetrated through the opening 14, the extending element 151 flexes and the fixing element(s) 152 travels on the surface of the conductor 30 until fixing into corresponding fixing portion(s) (not shown) on the conductor 30, thereby limiting the direction of the conductor 30 after penetrating the opening 14. For example, the extending element 151 can be implemented as a beam for supporting the conductor 30, and the fixing element(s) 152 can be implemented as pin(s) for fixing in hole(s) on the conductor 30, but not limited thereto. In addition, the conductor 30 which penetrates the opening 14 and guided by the guiding element 15 further penetrates the hollow portion 171d of the second base 17d, so as to complete the penetration through the passage 21.

The number and the positions of the first position-limiting elements 12d can be varied according to the practical requirements. For example, it can be implemented to be two or four first position-limiting elements 12d, similar to the embodiments shown in FIG. 1, FIG. 4 and FIG. 5, at opposite positions in one or two pairs without limitation for fitting to different shapes of the passages of different current transformers.

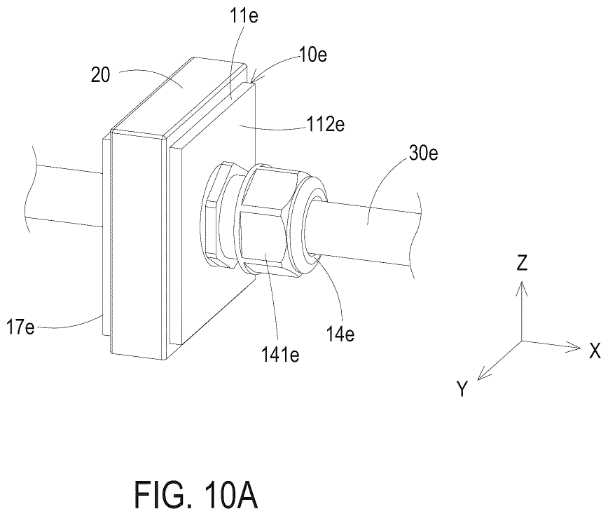

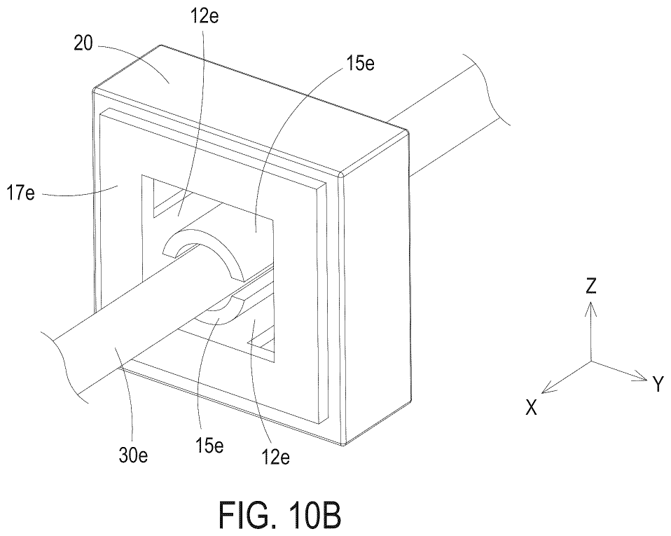

Furthermore, in response to different types of conductors penetrating the current transformer, the opening and the guiding element of the current transformer holder also can be varied. In an embodiment, as shown in FIGS. 10A-10B, a conductor 30e is a cable or a rod with a round section. Accordingly, a current transformer holder 10e which includes a first base 11e, a second base 17e, first position-limiting elements 12e, an opening 14e and guiding elements 15e is provided. The current transformer 20 is limited between the first base 11e and the second base 17e, the opening 14e is configured to have a similar round section for limiting the movement of the conductor 30e, and the guiding elements 15e are respectively configured as cambered elements for surrounding the outer surface of the conductor 30e so as to guide the direction of the conductor 30e through clamping or friction. In an embodiment, the current transformer holder 10e further includes a surrounding structure 141e protruded from the second surface 112e of the first base Ile to form the opening 14e, so as to cooperate with the guiding elements 15e for further ensuring the penetrating direction of the conductor 30e, but limited thereto. In other embodiments, it also can be implemented to have single guiding element 15e or more than two guiding elements 15e in accordance with practical requirements without limitation. In other embodiments, the guiding element(s) may be configured to be any structure capable of providing the function of clamping and/or friction, such as a clamp, a wire tie or a gland, but not limited thereto. Therefore, the number and detailed structures of the guiding element(s) and the shape of the opening can be varied according to practical requirements for achieving the purpose of fixing and/or holding the conductor without limitation.

Consequently, the current transformer holder of the present disclosure is capable of assembling in the passage of the current transformer and holding the conductor penetrating the passage of the current transformer in a self-aligning manner without employing additional fixing element. Therefore, the labor loading and the manufacturing cost both can be reduced, and simultaneously, the shock and vibrations transferred from the conductor to the current transformer can be minimized.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A current transformer holder for holding a conductor penetrating a passage of a current transformer, comprising:
a base comprising a first surface and a second surface opposite to each other;
a plurality of first position-limiting elements disposed on the first surface of the base for maintaining the current transformer holder in the passage of the current transformer;
a plurality of second position-limiting elements respectively disposed on the plurality of first position-limiting elements for defining a positional relationship between the current transformer holder and the current transformer;
an opening disposed on the base for being penetrated by the conductor so as to define a position of the conductor within the passage of the current transformer; and
at least one guiding element disposed on the base at a position corresponding to the opening for guiding a direction of the conductor within the passage of the current transformer.

2. The current transformer holder according to claim 1, wherein the current transformer comprises a third surface and a fourth surface opposite to each other, and when the current transformer holder is assembled with the current transformer, the first surface of the base is abutted on the third surface, the plurality of first position-limiting elements are abutted on at least one inner edge surface of the passage, and the plurality of second position-limiting elements are abutted on the fourth surface of the current transformer.

3. The current transformer holder according to claim 1, wherein the plurality of first position-limiting elements are extended from the first surface of the base in a direction substantially parallel to a normal direction of the first surface and form a space thereamong, and each of the plurality of second position-limiting elements is extended from a corresponding one of the plurality of first position-limiting elements in a direction away from the space.

4. The current transformer holder according to claim 3, wherein the opening is located at a position corresponding to the space, and the at least one guiding element is extended in the space.

5. The current transformer holder according to claim 1, wherein the plurality of first position-limiting elements are arranged in pairs, and every two paired ones of the plurality of first position-limiting elements are disposed at opposite positions.

6. The current transformer holder according to claim 1, wherein extension directions of the plurality of second position-limiting elements are substantially parallel to the first surface of the base.

7. The current transformer holder according to claim 1, wherein the at least one guiding element is extended from the first surface or from the first surface and the second surface of the base in a direction substantially parallel to a normal direction of the first surface and substantially parallel to extension directions of the plurality of first position-limiting elements.

8. The current transformer holder according to claim 1, wherein each of the at least one guiding element comprises an extending element and at least one fixing element, the extending element supports the conductor, and the at least one fixing element fixes with at least one corresponding fixing portion on the conductor.

9. The current transformer holder according to claim 1, wherein the at least one guiding element is configured to mate to an outer surface of the conductor.

10. The current transformer holder according to claim 1, wherein a shape of the opening is substantially identical to a section shape of the conductor.

11. The current transformer holder according to claim 1, further comprising a surrounding structure protruded from the second surface of the base to form the opening.

12. The current transformer holder according to claim 1, wherein the current transformer holder is integrally formed as one piece.

13. The current transformer holder according to claim 1, wherein the passage of the current transformer has a shape selected from the group consisting of a rectangular shape, a circular shape, a stepped shape and an arbitrary shape.

14. A current transformer holder for holding a conductor penetrating a passage of a current transformer, comprising:
a first base comprising a first surface and a second surface opposite to each other;
a second base parallel to the first base and adjacent to the first surface of the first base;
a plurality of first position-limiting elements disposed between the first base and the second base for maintaining the current transformer holder in the passage of the current transformer;
an opening disposed on the first base for being penetrated by the conductor so as to define a position of the conductor within the passage of the current transformer; and
at least one guiding element disposed on the first base at a position corresponding to the opening for guiding a direction of the conductor within the passage of the current transformer.

15. The current transformer holder according to claim 14, wherein the current transformer comprises a third surface and a fourth surface opposite to each other, and when the current transformer holder is assembled with the current transformer, the first surface of the first base is abutted on the third surface, the plurality of first position-limiting elements are abutted on at least one inner edge surface of the passage, and the second base is abutted on the fourth surface of the current transformer.

16. The current transformer holder according to claim 14, wherein the plurality of first position-limiting elements are extended in a direction substantially parallel to a normal direction of the first surface and form a space thereamong.

17. The current transformer holder according to claim 16, wherein the second base comprises a hollow portion disposed thereon at a position corresponding to the space among the plurality of first position-limiting elements.

18. The current transformer holder according to claim 16, wherein the opening is at a position corresponding to the space, and the at least one guiding element is extended in the space.

19. The current transformer holder according to claim 14, further comprising a surrounding structure protruded from the second surface of the first base to form the opening.

20. The current transformer holder according to claim 14, wherein the at least one guiding element is extended from the first surface or from the first surface and the second surface of the first base in a direction substantially parallel to a normal direction of the first surface and substantially parallel to extension directions of the plurality of first position-limiting elements.
